(19) United States
(12) Patent Application Publication
(10) Pub. No.: US 2025/0114917 A1
(43) Pub. Date: Apr. 10, 2025

(54) Adjustable Wrench

(71) Applicants: Johnnie F. Davidson, Fort Worth, TX (US); Thomas C. Davidson, Fort Worth, TX (US)

(72) Inventors: Johnnie F. Davidson, Fort Worth, TX (US); Thomas C. Davidson, Fort Worth, TX (US)

(21) Appl. No.: 18/769,714

(22) Filed: Jul. 11, 2024

Related U.S. Application Data
(60) Provisional application No. 63/513,681, filed on Jul. 14, 2023.
(60) Provisional application No. 63/513,689, filed on Jul. 14, 2023.

(51) Int. Cl. B25B 13/18; B25B 13/16

(52) U.S. Cl. CPC B25B 13/18; B25B 13/16

(57) ABSTRACT

An adjustable wrench is shown which includes a handle with a terminal end and a grip end, the terminal end defining a lower bolt claw. A tighten handle is coupled to an adjustment knob-nut. The adjustment knob is-nut is rotationally coupled to a jackscrew with the jackscrew being slidably coupled to the handle and is moveable to control the movement of associated upper and central bolt claws. The upper, central and lower bolt claws are adjustable to different sized bolt heads upon terminal or distal movement of the jackscrew. The central bolt claw fits through a slot in the upper bolt claw, the slot defining an inclined ramp surface, with movement of one claw being coupled to movement of the other claw. The claws move cooperatively in reaction to the stationary, lower bolt claw to form a tightly fitted surface for the bolt head. The jackscrew is manually adjusted during adjustment of the wrench to a bolt. Additionally, the jackscrew is distally biased within a slotted opening of the handle and can be moved forward to forcefully grip a bolt head, using the force multiplying tighten lever.

### 1. CROSS-REFERENCE TO RELATED APPLICATIONS

The present application claims priority from a previously filed provisional application Serial No. 63/513,681, filed Jul. 14, 2023, and from a second previously filed provisional application Serial No. 63/513,689, also filed Jul. 14, 2023, both entitled “Adjustable Wrench,” by the same inventor, Johnnie Fred Davidson.

### 2. FIELD OF THE INVENTION

The present invention relates in general to an adjustable bolt wrench and, in particular, to an adjustable, three-jawed wrench which can be adjusted for any size hexagonal bolt.

### 3. DESCRIPTION OF THE PRIOR ART

Bolt wrenches are an old art. There are primarily three general types of wrenches: socket wrenches, fixed end wrenches, and adjustable wrenches. In each type of wrench, there are several common ideal features. The wrench should be easy to use, since one-handed applications may be necessary in practice. Second, the head of the wrench, the section of the wrench that actually grips a bolt, must be able to grip the bolt in such a way that the corners of the standard hexagonal bolts are not stripped. Once stripped, the bolts become very difficult if not impossible to work with, and must be mechanically cut and replaced. Preferably, the wrench should be simple in design and economical to manufacture.

Of the three basic types of wrenches in current use, adjustable wrenches offer the most versatility. Further, adjustable wrenches are easier to use than socket or fixed end wrenches, both of which require the user to either replace the socket for different applications or change out the entire wrench. This is time consuming and tedious in many working conditions. An adjustable wrench allows the user to adjust a single tool unit to the various shapes and sizes of bolts, both metric and standard.

A primary drawback of adjustable wrenches is their gripping ability. Specifically, adjustable wrenches currently available are not able to fit a bolt as snugly as a socket or a fixed end wrench. This often leads to stripping of the bolt head, which further complicates the loosening or tightening of a bolt. Generally, the advantage that socket and fixed end wrenches have in this regard is an increased contact area with the bolt head. Socket and fixed end wrenches are typically designed to contact each of the six corners of the bolt head as well as each side. The greater the contact area, the tighter the fit between the wrench and bolt. Thus, what is needed is a wrench that has the versatility of an adjustable wrench, but also the advantages of fixed and socket wrenches.

Most adjustable wrenches have two bolt claws that are adjustable relative to each other to contact the bolt head, typically on two opposing sides of the hexagonal bolt. Increasing the number of sides contacted, and the number of corners contacted would be ideal. This could be accomplished by increasing the number of bolt claws on the adjustable wrench, thus increasing the surface area of the bolt head contacted. There are pliers in the art that have such a feature. For instance, the Stallings (U.S. Pat. Nos. 1,250, 690 and 1,498,488) inventions are pliers with two opposing claws, with a third pivotally mounted claw located central to the other two. The claw contact region is a complex structure, and the use of these pliers is directed towards general gripping of rounded surfaces such as pipes. These devices would not be suitable for a bolt wrench.

There are several other inventions directed towards an adjustable wrench. The Whelan (U.S. Pat. No. 1,401,931) invention is an adjustable pipe wrench that uses two opposing complex surfaced claws for gripping a pipe, with a third attachment coupled in such a manner to allow both parts to slide and pivot, increasing the contact surface area of the pipe being gripped. The Wei (U.S. Pat. No. 5,542,319) invention is an adjustable bolt wrench using two opposing bolt claws with a ratcheted handle. Although an improvement on the prior art, these two devices are either not directed towards a bolt wrench, or do not incorporate the advantages of fixed end wrenches by increasing the contact area of the bolt head and wrench. Thus, there continues to be a need for a wrench that incorporates the case of use of an adjustable wrench with the advantages of fixed end and socket wrenches.

U.S. Pat. No. 6,205,892, issued Mar. 27, 2001, and U.S. Pat. No. 7,174,813, issued Feb. 13, 2007, both issued to the present inventor, represented improvements in providing a wrench with increased surface contact between the wrench head and the bolt being gripped. While representing an advance in the art at the time, the present invention is directed toward further improvements in that basic design.

### SUMMARY OF THE INVENTION

An adjustable wrench is shown which includes a handle with a terminal end and a grip end. The terminal end defines a lower bolt claw. A jack-screw is coupled to the handle. A tighten handle is coupled to an adjustment knob-nut. The adjustment knob-nut is rotationally coupled to the jack-screw. A compression spring on the jack-screw biases the adjustment knob-nut and jack-screw in a distal direction relative to the terminal end of the wrench. A central bolt claw is coupled to the jackscrew. An upper bolt claw is coupled to the central bolt claw and to the handle for simultaneous movement therewith. The upper, central and lower bolt claws define a fitted opening which forms a portion of the shape of a standard hexagonal bolt head. The fitted opening is adjustable to fit different sized bolt heads upon movement of the jackscrew relative to the handle. The fitted opening defined by the upper, central and lower bolt claws encircles two sides and three corners of the hexagonal bolt head being received therein and partially encircles four remaining sides of the bolt head.

Preferably, the jackscrew is slidably coupled to the handle. The central bolt claw is operably connected to the jackscrew and includes a slidable connection to the upper bolt claw. The central bolt claw moves on an axis which intersects an opening formed between the upper bolt claw and the lower bolt claw. The jackscrew is movable between a distal position and a terminal position with respect to the handle. The central bolt claw is fitted through a groove in the lower bolt claw which defines an inclined ramp surface.

Additional objects, features and advantages will be apparent in the written description which follows.

### BRIEF DESCRIPTION OF THE DRAWINGS

FIG. 1 is a side, perspective view of the improved adjustable wrench of the invention with the jaws thereof being moved toward a fully closed position.

FIG. 2 is a perspective view, similar to FIG. 1, showing the jaws of the wrench being moved toward the wide-open position.

FIG. 3 is a side view of the wrench of FIG. 2 with portions broken away to illustrate the internal workings thereof, the wrench being shown with a relaxed tighten handle and with a distally shifted adjustment knob-nut, jack-screw and central jaw.

FIG. 4 is a view similar to FIG. 3, but showing the jaws of the wrench forcefully gripping a nut by force being applied to the tighten handle and greater force being directed in a terminal end direction to the adjustment knob-nut, jack-screw and thus to the central bolt claw, the upper bolt claw and the lower bolt claw to forcefully grip a nut.

### DETAILED DESCRIPTION OF THE INVENTION

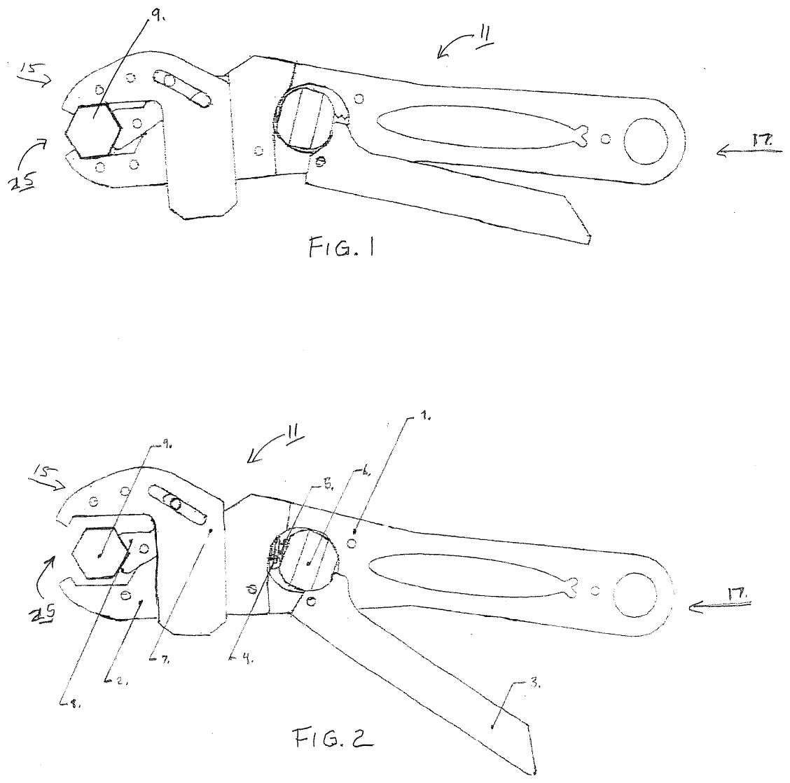

Turning first to FIGS. 1-2, there is shown one version of an adjustable wrench of the invention, designated generally as 11. In FIG. 1, the wrench 11 is shown in the closed position gripping a nut 9. With reference to FIG. 2, the wrench 11 includes a handle 1 with a distal end 17 and a gripping or terminal end 15. The terminal end 15 defines a lower bolt claw 2.

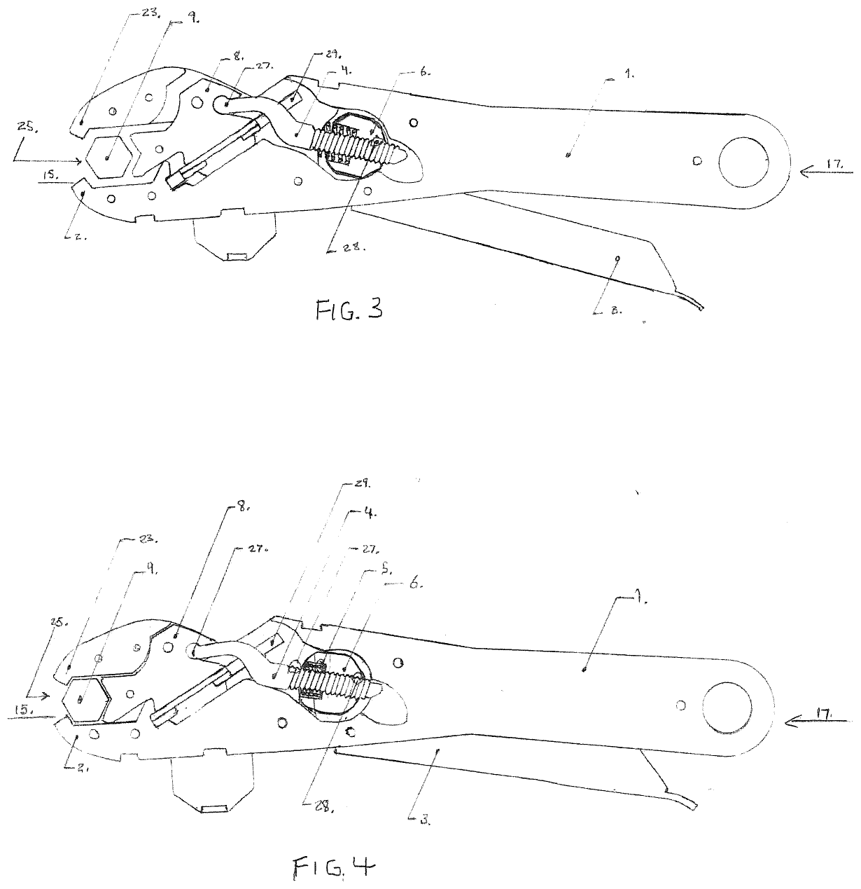

With further reference to FIGS. 2, 3 and 4, a jackscrew 4 is coupled to the handle and is movable with respect thereto by means of an adjustment knob-nut 6 which is located on a threaded external 9 surface of the jackscrew 4. A central bolt claw 8 (best seen in FIGS. 3 and 4) is coupled to the jackscrew 4 and an upper bolt claw 23 is coupled to the central bolt claw 8 and to the handle for simultaneous movement therewith.

The upper, central, and lower bolt claws define a fitted opening (generally at 25 in FIGS. 1 and 2) which forms a portion of the shape of a standard hexagonal bolt head (shown as 9 in FIG. 2), the fitted opening being adjustable to fit different sized bolt heads upon movement of the jackscrew relative to the handle.

The fitted opening 25 defined by the upper, central and lower bolt claws encircles two sides and three corners of the hexagonal bolt head 9 being received therein and partially encircles four remaining sides of the bolt head in use (see FIGS. 3 and 4).

As shown in FIGS. 3 and 4, the jackscrew 4 is slidably coupled to the handle 1. Turning the adjustment knob-nut 6 causes the jackscrew to travel back and forth along a longitudinal axis generally parallel to the central axis of the handle 1. The central bolt claw 8 is operably connected to the jackscrew 4 and includes a slidable connection to the upper bolt claw. The central bolt claw 8 moves on an axis which intersects an opening formed between the upper bolt claw and the lower bolt claw. As viewed in FIGS. 3 and 4, the central bolt claw 8 rides in the slot 29. The central bolt claw is acted upon by a jack-screw (4 in FIGS. 3 and 4) which is, in turn, connected to an outer extent of the shaft of the jackscrew 4 terminal extent 27.

With reference again to FIGS. 3 and 4, the FIG.'s provide a partial sectional view of the jackscrew with its externally threaded surface, shown matingly engaging the adjustment knob-nut 6. The adjustment knob-nut 6 is actually provided as a “ball knob” which has an internally threaded bore (28 in FIG. 4). Turning the ball knob 6 causes the jackscrew body to the left of the threaded surface (as viewed in FIGS. 3 and 4) to act as a driver element. The jackscrew 4 again has an externally threaded surface 27 for matingly engaging the ball knob 6. Turning the ball knob causes the driver element 4 to travel longitudinally as the ball knob is turned. The outermost extent 27 of the jackscrew 4 forms a rounded protuberance which cooperates with the central bolt claw 8, whereby turning the adjustment knob-nut 6 causes the jackscrew 4 to move the central bolt claw 8 inwardly and outwardly with respect to the fitted opening 25 of the wrench.

It can be seen that the jackscrew 4 is movable between a distal position and a terminal position with respect to the handle in order to determine the position of the central bolt claw 8 within the fitted opening 25 of the wrench. A bias spring (5 in FIGS. 2 and 4) is located on the externally threaded surface of the jackscrew 4 and is partially received within a cavity of the ball knob 6 on the terminal side of the adjustment knob-nut. FIG's. 3 and 4 further illustrate the slot or groove 29 in which the central bolt claw 8 is preferably fitted. The slot or groove provided in the lower bolt claw (16 in FIG. 3) defines an inclined ramp surface. The fitted opening of the wrench, illustrated as 25 in FIG. 1, thus forms a portion of the shape of a standard hexagonal bolt head, the fitted opening being adjustable to fit different sized bolt heads upon movement of the jack-screw 4 between distal and terminal positions relative to the handle (as illustrated in FIGS. 1-2 and 3-4). The upper and lower bolt claws have terminal outer extents (23 in FIGS. 3 and 4) which are 23 specifically fitted for gripping two sides and three corners of bolt being gripped.

In use, the wrench can be adjusted very close to the size of a nut. This is accomplished by gripping the tighten handle lever, which grips a nut with great force. Then, the user turns the nut with the wrench. Releasing the tighten handle lever causes the claws to move away from nut. The wrench can then be rotated to another grip position. Then wrench is again gripped forcefully again and the operation can be repeated. This series of steps serves to effectively ratchet the nut on or off.

An invention has been provided with several advantages. The improved wrench of the invention has claws which move cooperatively in reaction to the stationary, lower bolt claw to form a tightly fitted surface for a bolt head. A simple jackscrew mechanism is manually adjusted during adjustment of the wrench to fit a variety of sizes of bolt heads. The improved design enables reduction of manufacturing costs, improved location of certain components, and the jackscrew feature enhances use and operation. While the handle/lower jaw of the wrench may be provided as a one-piece hardened forging, it is also possible that a majority of the component parts of the wrench may be constructed of laminations, providing a wrench capable of exerting the necessary torque. The construction of the wrench also lends itself to automated and relatively inexpensive production.

While the invention has been shown in only two of its forms, it is not thus limited but is susceptible to various changes and modifications without departing from the spirit thereof.

What is claimed is:

1. An adjustable wrench comprising:
a handle with a terminal end and a grip end, the terminal end defining a lower bolt claw;
a jackscrew coupled to the handle;
a tighten handle coupled to an adjustment knob-nut;
the adjustment knob-nut being rotationally coupled to the jack-screw;
a compression-spring located on the jack-screw and biasing the adjustment knob-nut and jack-screw distally;
a central bolt claw coupled to the jackscrew;
an upper bolt claw coupled to the central bolt claw and to the handle for simultaneous movement therewith;
the upper, central, and lower bolt claws defining a fitted opening which forms a portion of the shape of a standard hexagonal bolt head, the fitted opening being adjustable to fit different sized bolt heads upon movement of the jackscrew relative to the handle; and
wherein the fitted opening defined by the upper, central and lower bolt claws encircles two sides and three corners of the hexagonal bolt head being received therein and partially encircles four remaining sides of the bolt head.

2. The adjustable wrench of claim 1, wherein the jack-screw is slidably coupled to the handle.

3. The adjustable wrench of claim 1, wherein the jack-screw adjustment knob-nut is screwed onto the jack-screw and coupled to a cavity in the handle.

4. The adjustable wrench of claim 1, wherein the central bolt claw is operably connected to the jackscrew and includes a slidable connection to the upper bolt claw.

5. The adjustable wrench of claim 1, wherein the adjustment knob-nut when rotated one way slides the jack-screw terminally, and rotated the other way, slides the jack-screw distally, therefore adjusting the wrench to different sized bolt heads.

6. The adjustable wrench of claim 1, wherein the tighten handle is operably connected to the adjustment knob-nut and the jack-screw by associated hinging on the wrench-handle, whereby a gripping force applied to the tighten handle serves to apply a gripping force to a bolt head being gripped.

7. The adjustable wrench of claim 1, wherein the central bolt claw moves on an axis which intersects an opening formed between the upper bolt claw and the lower bolt claw.

8. The adjustable wrench of claim 1, wherein a bias-spring is located co-axially about the jack-screw on the terminal side of the adjustment knob-nut.

9. The adjustable wrench of claim 1, wherein the jackscrew is movable between a distal position and a terminal position with respect to the handle, by rotating the adjustment knob-nut so that movement of the jackscrew serves to move the central bolt claw inwardly and outwardly, respectively, with respect to the fitted opening defined by the upper, central and lower bolt claws.

10. The adjustable wrench of claim 1, wherein the central bolt claw is fitted through a groove provided in the lower bolt claw defining an inclined ramp surface.

11. An adjustable wrench comprising:
a handle with a terminal end and a grip end, the terminal end defining a lower bolt claw;
a jackscrew coupled to the handle for sliding movement relative to the handle;
an adjustment knob-nut rotationally coupled to the jack-screw;
a bias-spring to hold the adjustment knob-nut distally;
a tighten handle to apply force to the adjustment knob-nut and jack-screw to grip a bolt head;
a central bolt claw coupled to the jackscrew;
an upper bolt claw coupled to the central bolt claw and to the handle;
and the upper, central, and lower bolt claws defining a fitted opening which forms a portion of the shape of a standard hexagonal bolt head, the fitted opening being adjustable to fit different sized bolt heads upon rotation of adjustment knob-nut which pulls or pushes the jackscrew between distal and terminal position relative to the handle.

12. The adjustable wrench of claim 7, wherein the central bolt claw is fitted through a slot in the lower bolt claw defining an inclined ramp surface.

13. The adjustable wrench of claim 11, wherein the jackscrew is located within a cavity provided in the wrench handle.

14. The adjustable wrench of claim 11, wherein the adjustment knob-nut is shorter than its cavity in the handle, and such that the adjustable wrench can shift only slightly in the terminal or distal directions when the tighten handle is gripped tightly, thus applying gripping force to a bolt head.

15. The adjustable wrench of claim 13, wherein the terminal end of the jackscrew is operatively associated with the central bolt claw.

16. The adjustable wrench of claim 15, wherein the upper, lower, and central bolt claws are fitted to the bolt head by movement of the jackscrew terminal end towards the handle terminal end.

17. The adjustable wrench of claim 11, wherein the jackscrew includes a push link portion which with the remainder of the jackscrew forms a single driver element.

18. The adjustable wrench of claim 17, wherein the upper, lower and central bolt claws have terminal outer extents which are specifically fitted for gripping two sides and three corners of a bolt head being gripped.
